(19) United States
(12) Patent Application Publication
(10) Pub. No.: US 2025/0153543 A1
(43) Pub. Date: May 15, 2025

(54) DEMISTING VEHICLE WINDOWS USING SINGLE OUTLET

(71) Applicant: Atieva, Inc., Newark, CA (US)

(72) Inventors: Lucas Jungmann, Newark, CA (US); Peter Hicks, Newark, CA (US); Ran Zhang, Fremont, CA (US)

(21) Appl. No.: 18/949,474

(22) Filed: Nov. 15, 2024

Related U.S. Application Data
(60) Provisional application No. 63/599,304, filed on Nov. 15, 2023.
(60) Provisional application No. 63/599,758, filed on Nov. 16, 2023.

(51) Int. Cl. B60H 1/24; B60J 1/00; B60J 1/10; B62D 25/04

(52) U.S. Cl. CPC B60H 1/243; B60J 1/10; B62D 25/04; B60J 1/002

(57) ABSTRACT

A vehicle comprises: a vehicle body having a passenger compartment with first and second glass panes, the first glass pane positioned on a side of the vehicle body between, and abutting each of, a first pillar and a second pillar of the vehicle body, the second glass pane abutting an opposite side of the second pillar from the first glass pane; an HVAC system, a duct delivering air from the HVAC system for the passenger compartment; and an outlet between the first and second pillars and adjacent the first glass pane and coupled to a distal end of the duct, the outlet including at least one vane defining multiple outlet channels for the air, the multiple outlet channels directed toward the second pillar, wherein the air reaches the first glass pane, and wherein the air reaches also the second glass pane due an aerodynamic effect of the second pillar.

### CROSS-REFERENCE TO RELATED APPLICATIONS

This application claims priority to U.S. Provisional Patent Application No. 63/599,304, filed on Nov. 15, 2023, entitled “DEMISTING OBSTRUCTED AUTOMOBILE SIDE WINDOWS,” the disclosure of which is incorporated by reference herein in its entirety.

This application also claims to U.S. Provisional Patent Application No. 63/599,758, filed on Nov. 16, 2023, entitled “DEMISTING OBSTRUCTED AUTOMOBILE SIDE WINDOWS,” the disclosure of which is incorporated by reference herein in its entirety.

### TECHNICAL FIELD

This document relates to demisting vehicle windows using a single outlet.

### BACKGROUND

Typically side windows of a vehicle are used for the driver and passenger to look into side traffic, look into the side view mirrors and inspect objects to the side in close proximity to the vehicle. Depending on the climate inside the vehicle the side windows can easily become fogged up or icy. As a result, it is not possible for the driver to see out the side windows. Typically, automobile manufacturers design a demisting duct and vent that are used to blow dried air from the heating, ventilation and air conditioning (HVAC) system to demist and remove moisture/ice from the interior window surfaces. Depending on the design of the vehicle one or two demisting outlets are needed to ensure that the windows are adequately ventilated with air. These vents require additional parts and typically work against the aesthetic vision of the designers.

### SUMMARY

In a first aspect, a vehicle comprises: a vehicle body having a passenger compartment with first and second glass panes, the first glass pane positioned on a side of the vehicle body between, and abutting each of, a first pillar and a second pillar of the vehicle body, the second glass pane abutting an opposite side of the second pillar from the first glass pane; a heating, ventilation and air conditioning (HVAC) system installed in the vehicle body, a duct extending from the HVAC system and delivering air for the passenger compartment; and an outlet positioned between the first and second pillars and adjacent the first glass pane, the outlet coupled to an end of the duct that is distal from the HVAC system, the outlet including at least one vane defining multiple outlet channels for the air, wherein the multiple outlet channels are directed toward the second pillar, wherein the air reaches the first glass pane, and wherein the air reaches also the second glass pane due an aerodynamic effect of the second pillar.

Implementations can include any or all of the following features. The first pillar is an A-pillar of the vehicle. The second pillar includes trim that provides the aerodynamic effect of the second pillar. The second pillar has first and second main exterior surfaces that abut each other, and wherein the multiple outlet channels face the first main surface. The first main surface is positioned forward of the second main surface in the vehicle. The multiple outlet channels are not directed toward the first glass pane. The multiple outlet channels are substantially parallel with the first glass pane. The multiple outlet channels are directed toward a remainder of the passenger compartment. Each of the multiple outlet channels is defined by the vane and by side walls of the outlet. The multiple outlet channels are substantially parallel with each other. Each of the multiple outlet channels is defined by an opening in the outlet, wherein a shape of the opening in a top view is substantially a rectangle. A short side of the rectangle faces the first glass pane, and wherein in the top view the rectangle is angled forward with respect to the first glass pane. The first glass pane is a quarter window of the vehicle. The vehicle includes a closure configured to open and close an opening to the passenger compartment, wherein at least the second glass pane is positioned on the closure. Also the first glass pane is positioned on the closure. The first glass pane is positioned on the vehicle body and not on the closure. The closure further includes a window elevator for the second glass pane. A line extends between i) a most inboard edge of the first pillar adjacent the outlet, and ii) a most inboard edge of the second pillar adjacent the outlet, and wherein the outlet is positioned outboard of the line.

In a second aspect, a vehicle comprises: a vehicle body having a passenger compartment with first and second glass panes, the first glass pane positioned on a side of the vehicle body between, and abutting each of, a first pillar and a second pillar of the vehicle body, wherein the second glass pane abuts an opposite side of the second pillar from the first glass pane; a heating, ventilation and air conditioning (HVAC) system installed in the vehicle body, a duct extending from the HVAC system and delivering air for the passenger compartment; and means for distributing air from the HVAC system to each of the first and second glass panes, the means positioned between the first and second pillars, wherein the air from the means reaches the first glass pane, and wherein the air from the means reaches also the second glass pane due to an aerodynamic effect of the second pillar.

A line extends between i) a most inboard edge of the first pillar adjacent the means, and ii) a most inboard of the second pillar adjacent the means, and the means can be positioned outboard of the line.

### BRIEF DESCRIPTION OF DRAWINGS

FIG. 1 shows an example of a vehicle with an outlet for air to demist windows.

FIG. 2 shows an example of a passenger compartment.

FIG. 3 schematically shows a partial section of the vehicle of FIG. 1.

FIG. 4 shows a partial section of the passenger compartment of the vehicle of FIG. 1 including an outlet.

FIG. 5 shows another partial section of the passenger compartment of the vehicle of FIG. 1.

FIG. 6 shows another partial section of the passenger compartment of the vehicle of FIG. 1.

FIG. 7 shows another partial section of the passenger compartment of the vehicle of FIG. 1.

FIG. 8 shows another partial section of the passenger compartment of the vehicle of FIG. 1.

FIG. 9 shows an example of a computer simulation of air distribution for windows of a vehicle.

FIG. 10 shows another example of a computer simulation of air distribution for a quarter window of a vehicle.

Like reference symbols in the various drawings indicate like elements.

### DETAILED DESCRIPTION

This document describes examples of systems and techniques that can allow successful demisting of front side and quarter windows of a vehicle even with trim obstructing direct air flow to the windows. The trim and air flow outlets can be designed with a curvature and outline to allow the dried air to flow over the seemingly obstructing surface and evenly distribute itself across the side and front windows to remove moisture allowing the driver to view both the side view mirror and out the window with ease. The present subject matter can address the situation where an additional window is added to a vehicle design, when such a window is also required to be cleared to help with visibility in foggy, cold or humid conditions. For example, using a single outlet to clear mist from two windows can both reduce manufacturing costs and help minimize the visual impact of the outlet to occupants.

The present subject matter can use a single outlet that is placed between the A-pillar trims and effectively demists two windows: both the quarter glass forward window and the main driver or passenger window, respectively. The demist outlet is not easily visible by the driver and is not placed on the main dashboard surface, resulting in a more aesthetic/sleek design. This outlet can be positioned directly behind the pillar trim, which can make it appear as if it were not possible for air from this outlet to effectively demist the side window of the vehicle. However, due to a multi part design considering the shape of the pillar trim, vein design and outlet position of the demisting outlet as well as airflow leading to the outlet the present subject matter can successfully demist the windows. For example, utilizing the Coanda effect of fluid dynamics as well as several other fundamental fluid dynamic principles a demisting effect for side windows can be achieved that helps reduce visibility of technical features, reduce cost and part complexity by reducing the number of ducts and parts and improve overall system performance with reduced pressure drop.

The present subject matter can provide a number of advantages, including, but not limited to, the following. Many challenges seen by typical original equipment manufacturers (OEMs) in the automotive space when designing two side windows can be resolved. The way that some OEMs hide the vanes of outlets, or the way they deliver air to the glass, can result in complex routing of the ducting. For example, the duct may then enter the door panels or the A-pillar of the vehicle. This requires more ducts and complex sealing surfaces and parts, resulting in a subpar design. As another example, extra blowers may be needed in the HVAC system to overcome the pressure drop. Using some fluid dynamic principles and multi part optimization the present subject matter can achieve a far simpler system that gives more with less. As such, cost can be lowered by reducing the number of parts. The styling can be improved by hiding a vent bezel from view by placing it in a position that is off of the instrument panel. Safety and visibility can be improved by dramatically reducing pillar size (e.g., by not needing to accommodate an HVAC duct inside the pillar), such as to reduce blind spots. An overall pressure drop of the HVAC system can be reduced by having fewer outlets. The complexity of the product can be lowered by using fewer parts.

Examples described herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle.

Examples described herein refer to a vehicle body. As used herein, a vehicle body includes also any closures (e.g., doors, liftgates, hoods or trunk lids) of the vehicle. As such, a component that is mounted to (e.g., positioned on) a vehicle body can, but does not have to be, mounted on a closure (e.g., on a door).

Examples described herein refer to a passenger compartment of a vehicle. As used herein, a passenger compartment has seating for one or more occupants, has one or more ingress and egress points (e.g., a door opening), and has windows for visibility out of and into the vehicle.

Examples described herein refer to a pillar of a vehicle. As used herein, a pillar can be a structurally reinforcing member of a vehicle body, or can be a mainly decorative element not designed for structural strength. Examples of structurally reinforcing members include, but are not limited to, A-pillars (e.g., a forward-most pillar of the vehicle that supports the roof at a corner of the windshield), B-pillars (e.g., a pillar supporting the roof immediately behind a first row of seats), C-pillars (e.g., a pillar supporting the roof immediately behind a second row of seats), and D-pillars (e.g., a rearmost pillar supporting the roof on larger passenger vehicles). Examples of non-structurally reinforcing members include, but are not limited to, trim that is applied to the vehicle body for decoration, such as to cover underlying structure or to bridge gaps between other vehicle components.

Examples described herein refer to a front, rear, top, or a bottom. These and similar expressions identify things or aspects in a relative way based on an express or arbitrary notion of perspective. That is, these terms are illustrative only, used for purposes of explanation, and do not necessarily indicate the only possible position, direction, and so on.

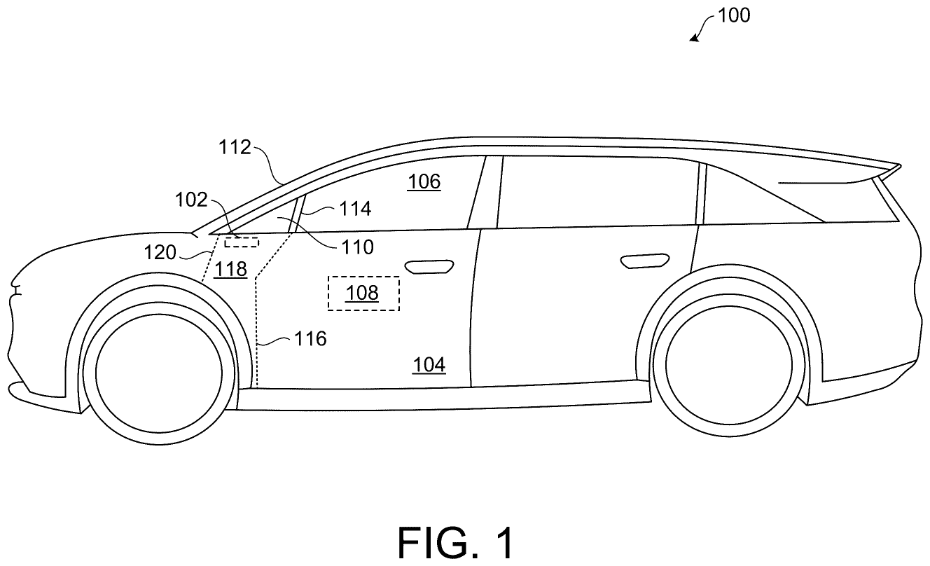

FIG. 1 shows an example of a vehicle 100 with an outlet 102 for air to demist windows. The vehicle 100 or the outlet 102 can be used with one or more other examples described elsewhere herein. The vehicle 100 is shown in a side view and some aspects thereof have been simplified or omitted for simplicity. For example, the outlet 102 is positioned inside the vehicle 100 and is schematically shown in phantom.

The vehicle 100 can have a vehicle body mounted on a chassis. The vehicle body defines a passenger compartment that can be equipped with one or more closures and windows. Here, a door 104 is mounted to the vehicle body to open and close a door opening to allow ingress and egress to the vehicle 100. The door 104 can correspond to a first-row seat of the vehicle 100 (e.g., a driver seat). A glass pane 106, which can be referred to as a side window, is positioned on the door 104. The door 104 can have a window elevator 108 (e.g., electric or mechanical) for raising or lowering the glass pane 106.

The vehicle 100 here has a glass pane 110. The glass pane 110 is positioned between an A-pillar 112 of the vehicle body and a pillar 114. The glass pane 110 can be referred to as a quarter window. The outlet 102 inside the passenger compartment is here positioned adjacent (e.g., inboard of) the glass pane 110. The outlet 102, which is coupled to a duct from an HVAC system of the vehicle 100, can provide demisting of both the glass pane 110 and the glass pane 106, as exemplified elsewhere herein. The pillar 114 can include trim that provides an aerodynamic effect on the air to allow air from the outlet 102 to reach also the glass pane 106.

This drawing illustrates that the glass pane 110 and the outlet 102 can either: both be positioned on the door 104, or both be positioned on the rest of the vehicle body. In some implementations, a boundary 116 on the vehicle body marks the forward-most edge of the door 104. Then, a body portion 118 is not part of the door 104 and does not open and close. For example, the pillar 114 can then extend between the body portion 118 and the A-pillar 112. That is, the glass pane 110 can be positioned on the vehicle body and not on the door 104.

In other implementations, however, the vehicle 100 may not have the boundary 116. Rather, the door 104 extends forward to a boundary 120. In those implementations, the body portion 118 is part of the door 104 and does open and close with the door 104. For example, the pillar 114 can then extend between a body and a window frame of the door 104. That is, the glass pane 110 can be positioned on the door 104.

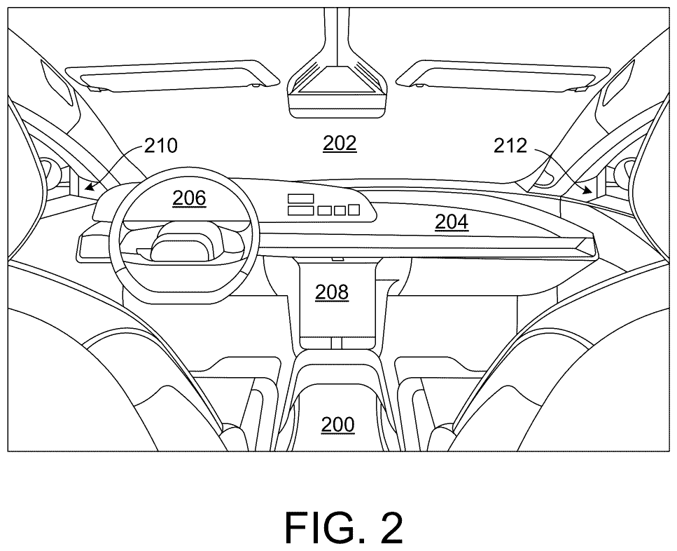

FIG. 2 shows an example of a passenger compartment 200. The passenger compartment 200 has a windshield 202, an instrument panel 204, a display device 206 (e.g., an instrument cluster) and/or a display device 208 (e.g., a center display). The passenger compartment 200 has a glass pane 210 on the left side of the vehicle, and a glass pane 212 on the right side of the vehicle, that can be referred to as quarter windows. As exemplified herein, respective outlets adjacent the respective glass panes 210 and 212 can provide demisting both of the quarter window and of an adjacent side window, without unnecessarily cluttering or detracting from the appearance of the instrument panel 204.

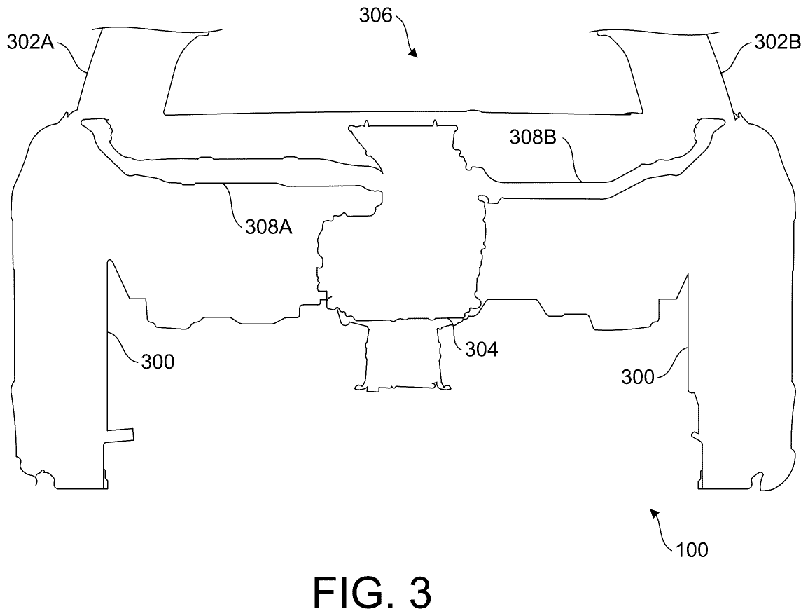

FIG. 3 schematically shows a partial section of the vehicle 100 of FIG. 1. This vertical section is taken transversely across the width of the vehicle 100. The illustration omits most details for clarity, and some components are shown only schematically. The vehicle 100 has a vehicle body 300 that defines A-pillars 302A-302B (partially shown) among other structures. The vehicle 100 includes an HVAC system 304 that is configured for providing heating, ventilation and air conditioning by circulation of air into at least a passenger compartment 306 (e.g., the passenger compartment 200 of FIG. 2). One or more ducts can be used in circulating the air. Here, a duct 308A extends from the HVAC system 304 toward the A-pillar 302A. Similarly, a duct 308B extends from the HVAC system 304 toward the A-pillar 302B. An outlet (e.g., the outlet 102 of FIG. 1) can be coupled to an end of the duct 308A that is distal to the HVAC system 304. Similarly, another outlet (e.g., another instance of the outlet 102 of FIG. 1) can be coupled to an end of the duct 308B that is distal to the HVAC system 304. Dried air from the HVAC system 304 can travel through the respective ducts 308A-308B to reach the passenger compartment 306. Particularly, on each side of the vehicle 100, the dried air from a single outlet can provide demisting of both a quarter window and a side window.

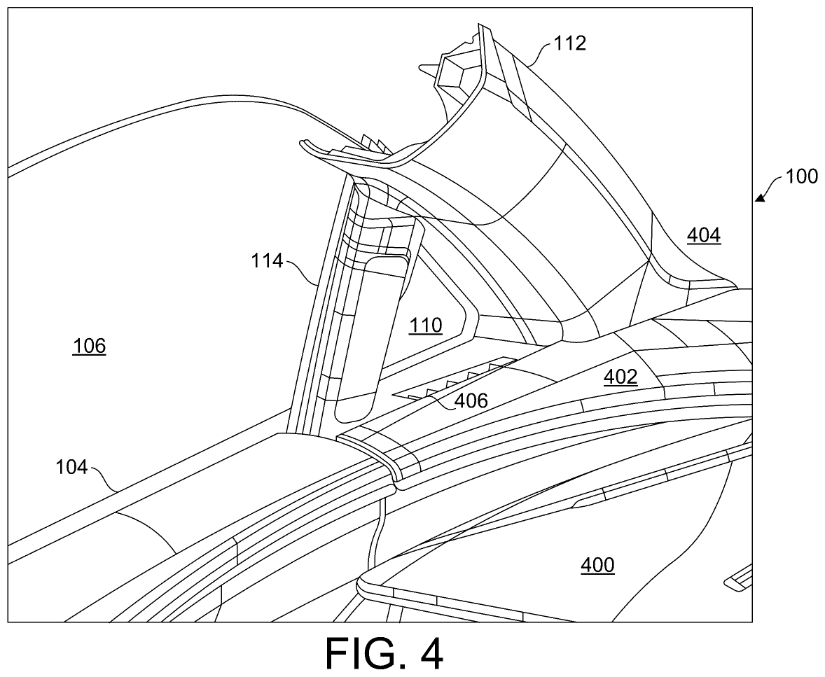

FIG. 4 shows a partial section of the passenger compartment of the vehicle 100 of FIG. 1 including an outlet. In this view, each of the door 104, the glass pane 106, the glass pane 110, the A-pillar 112 and the pillar 114 are at least partially visible. The vehicle 100 here has a dashboard 400 on which a steering wheel, controls, and an infotainment center, among other components, can be positioned. Adjacent the dashboard 400 is trim 402 that can extend from an area adjacent a base of a windshield 404, past the A-pillar 112, and end adjacent the base of the pillar 114.

That is, the trim 402 may be needed in the vehicle design at least in part because of a gap between the A-pillar 112 and the pillar 114, or to cover other structure. Given that a component will be installed between the A-pillar 112 and the pillar 114, it is advantageous to place an outlet 406 of the HVAC system therein, to avoid having another opening in the dashboard 400.

However, placing a single HVAC outlet between the A-pillar 112 and the pillar 114 for demisting both the glass pane 106 and the glass pane 110 may seem challenging because the pillar 114 is physically in the way of the air stream toward the glass pane 106. One concern may be that the air from the outlet 406 would simply bounce off the pillar 114 and not effectively reach the glass pane 106. However, the geometry of the outlet 406 and of the pillar 114 can be designed to use an aerodynamic effect to enable the air stream to bend around the pillar 114. In some implementations, this aerodynamic effect can be the Coanda effect. For example, the aerodynamic effect can utilize a low-pressure zone that is formed adjacent the pillar 114 such that the pressure of the ambient air of the passenger compartment urges the air stream to remain in contact with the surface of the pillar 114. As such, the aerodynamic effect can help keep both the glass pane 106 and the glass pane 110 clear while minimizing the number of parts and avoiding unwanted effects on the aesthetics of the dashboard 400.

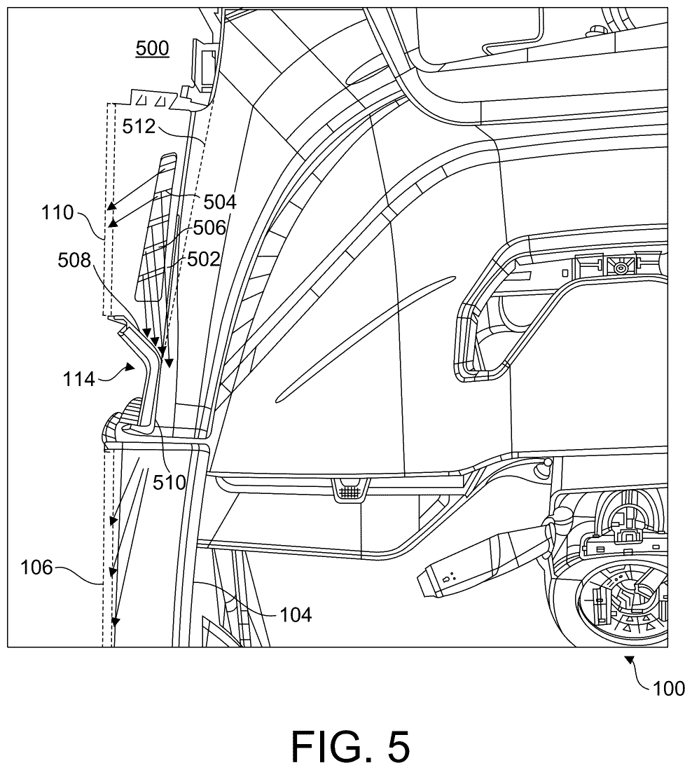

FIG. 5 shows another partial section of the passenger compartment of the vehicle 100 of FIG. 1. In this top view, each of the door 104, the glass pane 106, the glass pane 110 and the pillar 114 are at least partially visible. The glass pane 106 and the glass pane 110 are schematically shown as dashed outlines. While the A-pillar 112 (FIG. 1) is not included in this view for simplicity, a location 500 indicates where the A-pillar can be positioned. That is, the location 500 indicates the farthest inboard that the A-pillar can be located in this implementation.

An outlet 502 is here positioned in the trim between the location 500 of the A-pillar and the pillar 114. The outlet 502 is coupled to a duct of an HVAC system. The outlet 502 includes at least one vane 504 defining outlet channels 506 for air from the outlet 502.

The pillar 114 can be provided with two or more main surfaces. Here, the pillar 114 has a main exterior surface 508 that is positioned forward of a main exterior surface 510, wherein the main exterior surfaces 508-510 abut each other. In some implementations, each of the main exterior surfaces 508-510 can be formed by trim that is applied to a structural pillar of the vehicle. The outlet channels 506 here face the main exterior surface 508.

Each of the outlet channels 506 can be defined by an opening in the outlet 502. The opening can have any of multiple shapes. In this view, a shape of the opening is substantially a rectangle. A short side of the faces the glass pane 110 (i.e., on the left side of the rectangle in this view). Here, the rectangle is angled forward with respect to the glass pane 110. For example, the other short side of the rectangle, opposite to the short side just mentioned, is here positioned further forward in the vehicle. This angle associated with the opening and the outlet channel can affect the direction of air flow through the outlet 502, for example as described elsewhere herein.

A line 512 is added in this view and illustrates that the outlet 502 can be positioned deep inside the space between the A-pillar and the pillar 114. The line 512 extends between a most inboard edge of the A-pillar adjacent the outlet 502 and a most inboard edge of the pillar 114 adjacent the outlet 502. The outlet 502, moreover, is positioned outboard of the line 512. That is, no part of the outlet 502 extends inboard past the A-pillar and the pillar 114. As such, the pillar 114 blocks every linear path for the air flow from the outlet 502 to the glass pane 106. Instead, the pillar 114 provides an aerodynamic effect on the air flow that allows the air to reach also the glass pane 106.

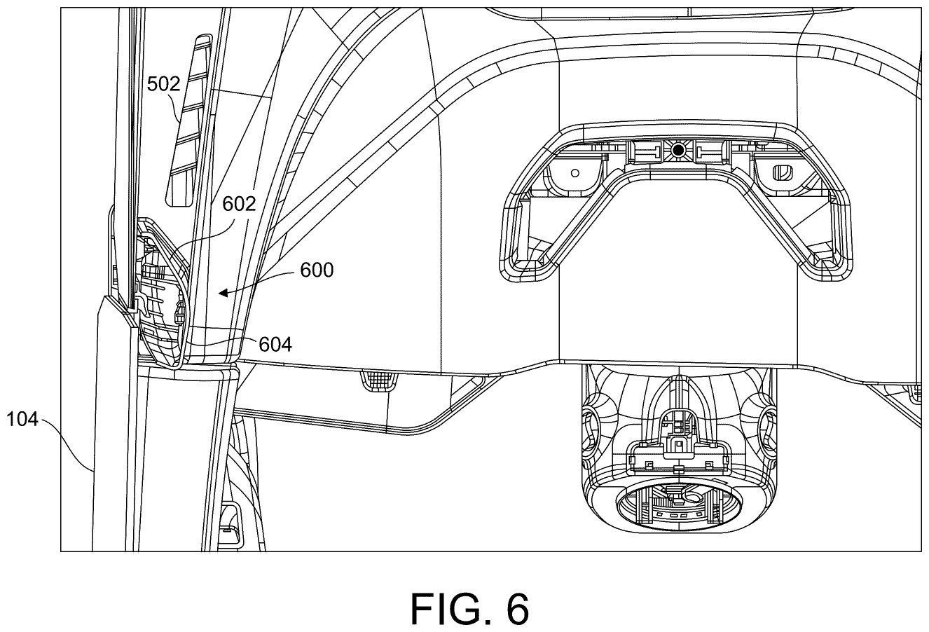

FIG. 6 shows another partial section of the passenger compartment of the vehicle 100 of FIG. 1. In this top view, the door 104, the outlet 502 and a pillar 600 are at least partially visible. The quarter window and the side window are omitted in this view for clarity, but the quarter window would be positioned adjacent the location of the outlet 502, similar to the illustration in FIG. 5.

The pillar 600 can be provided with two or more main surfaces. Here, the pillar 600 has a main surface 602 that is positioned forward of a main surface 604, wherein the main surfaces 602-604 abut each other. In some implementations, each of the main surfaces 602-604 can be formed by trim that is applied to a structural pillar of the vehicle. The outlet channels of the outlet 502 here face the main surface 602. Similarly here, the pillar 600 provides an aerodynamic effect on the air flow from the outlet 502 that allows the air to reach also the side window.

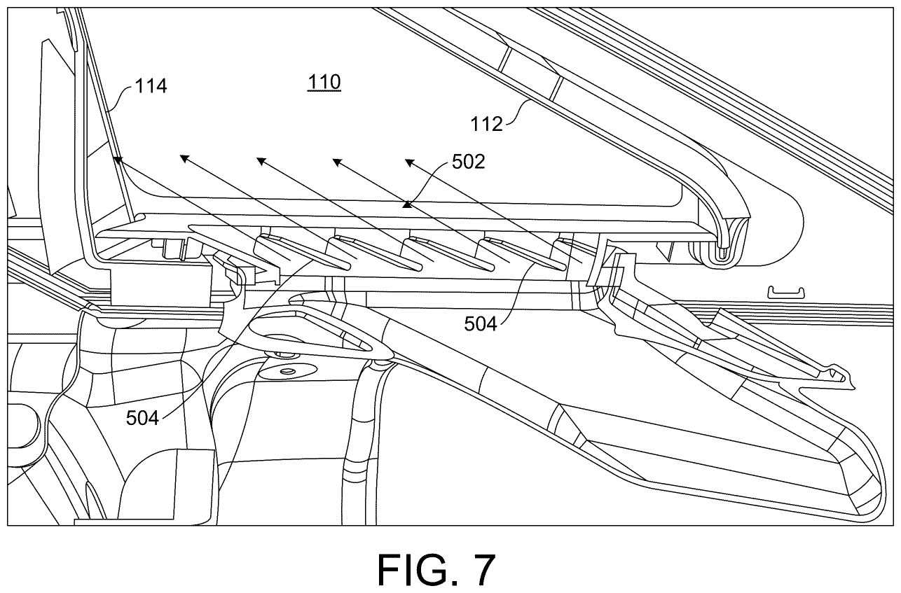

FIG. 7 shows another partial section of the passenger compartment of the vehicle 100 of FIG. 1. This vertical section is taken longitudinally in the vehicle 100 and the view looks in an outboard direction through the glass pane 110. The outlet 502 is here positioned in the trim between the A-pillar 112 and the pillar 114. The vanes 504 are seen to define the outlet channels 506 such that the flow of air is oriented rearward in the vehicle, in a direction toward the pillar 114, as indicated by the arrows. The vanes 504 and the side walls of the outlet 502 can be shaped so that the outlet channels 506 are substantially parallel with each other. The geometry of the outlet 502, together with the shape of the pillar 114, can allow air from the outlet 502 to reach also a side window blocked by the pillar 114, for example as described elsewhere herein.

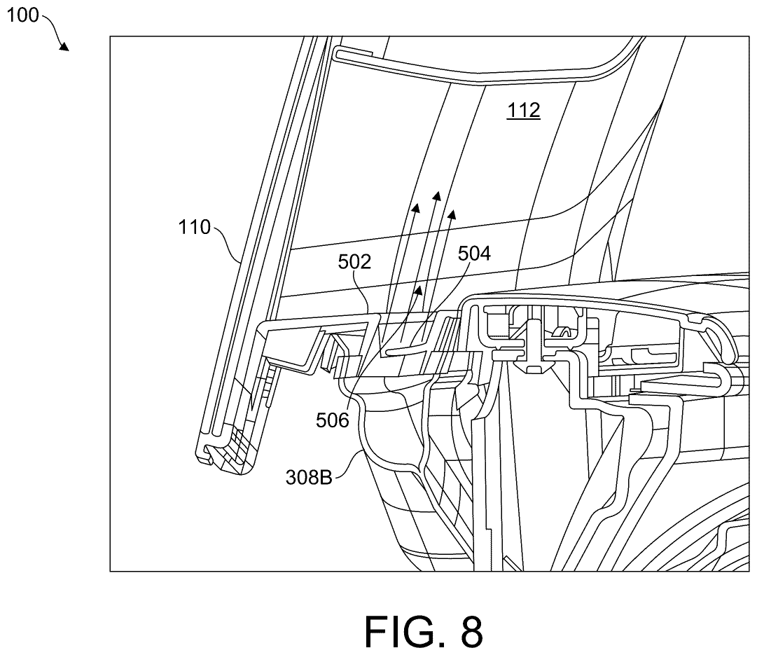

FIG. 8 shows another partial section of the passenger compartment of the vehicle 100 of FIG. 1. This vertical section is taken transversely across the width of the vehicle 100. In this view looking forward in the vehicle 100, the glass pane 106, the A-pillar 112, the duct 308B (FIG. 3) and the outlet 502 are at least partially visible. That is, the duct 308B delivers dried air to the outlet 502 for demisting. The geometry of the outlet 502, including its side walls and the vanes 504 that define the outlet channels 506, and also the shape of a rearward pillar (e.g., the pillar 114 in FIG. 1), can allow air from the outlet 502 to reach also a side window blocked by the pillar 114, for example as described elsewhere herein. Arrows show that the outlet channels 506 are not directed toward the glass pane 110. The arrows show that the outlet channels 506 can be substantially parallel with the glass pane 110. The arrows show that the outlet channels 506 can be directed toward a remainder of the passenger compartment. That is, this geometry of the outlet 502 is not the typical design of a demisting vent, whose vanes are usually directed toward the window (here the glass pane 110) that is to be demisted. Rather, the outlet channels 506 are here pointed inward in the vehicle (see the present drawing) and also aimed toward the pillar 114 (see FIG. 7), while able to provide demisting of both a quarter window and a side window.

The above examples illustrate that a vehicle (e.g., vehicle 100 of FIG. 1) can include: a vehicle body (e.g., the vehicle body 300 in FIG. 3) having a passenger compartment (e.g., the passenger compartment 200 in FIG. 2) with first and second (e.g., the glass panes 110 and 106 of FIG. 1) glass panes, the first glass pane positioned on a side of the vehicle body between, and abutting each of, a first pillar (e.g., the a-pillar 112 of FIG. 1) and a second pillar (e.g., the pillar 114 of FIG. 1) of the vehicle body, the second glass pane abutting an opposite side of the second pillar from the first glass pane; an HVAC system (e.g., the HVAC system 304 of FIG. 3) installed in the vehicle body, a duct (e.g., the duct 308A or 308B of FIG. 3) extending from the HVAC system and delivering air for the passenger compartment; and an outlet (e.g., the outlet 102 of FIG. 1, the outlet 406 of FIG. 4, or the outlet 502 of FIG. 5) positioned between the first and second pillars and adjacent the first glass pane, the outlet coupled to an end of the duct that is distal from the HVAC system, the outlet including at least one vane (e.g., the vanes 504 of FIG. 5) defining multiple outlet channels (e.g., the outlet channels 506 of FIG. 5) for the air, wherein the multiple outlet channels are directed toward the second pillar, wherein the air reaches the first glass pane, and wherein the air reaches also the second glass pane due an aerodynamic effect of the second pillar. That is, the outlet (e.g., the outlet 102 of FIG. 1, the outlet 406 of FIG. 4, or the outlet 502 of FIG. 5) can distribute air from the HVAC system to each of the first and second glass panes.

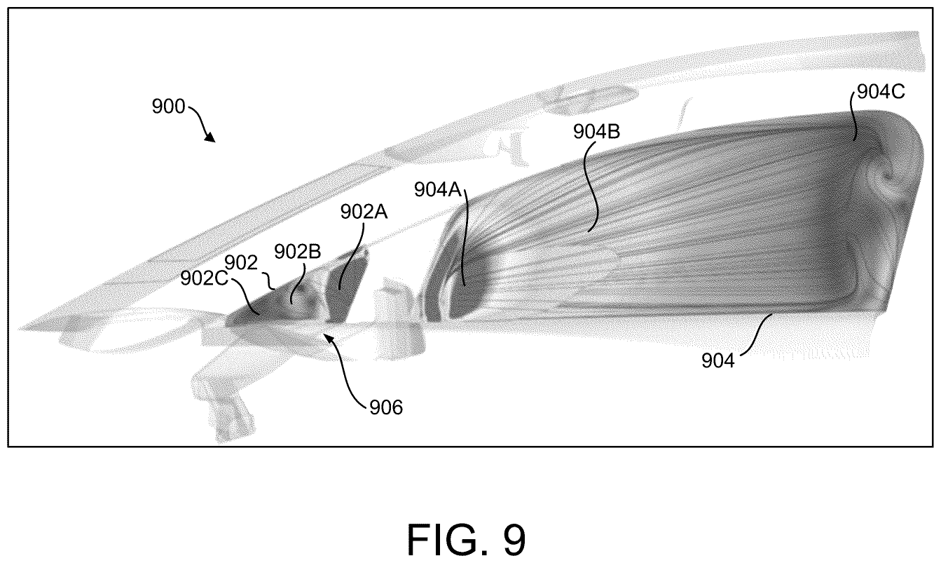

FIG. 9 shows an example of a computer simulation 900 of air distribution for windows of a vehicle. The computer simulation 900 can be used with one or more other examples described elsewhere herein. The computer simulation 900 is performed based on a glass pane 902 (e.g., a quarter window) and a glass pane 904 (e.g., a side window), with air flowing out of an outlet 906. The pressure of the air flow at various locations of the glass panes 902-904 is indicated by the shading in the computer simulation 900. The glass pane 902 has an area 902A of relatively high air pressure, an area 902B of medium air pressure, and an area 902C of relatively low air pressure. As such, it can be determined that the glass pane 902 will be cleared (e.g., demisted) by the flow of air from the outlet 906.

Similarly, the glass pane 904 has an area 904A of relatively high air pressure, an area 904B of medium air pressure, and an area 904C of relatively low air pressure. As such, it can be determined that the glass pane 904 will be cleared (e.g., demisted) by the flow of air from the outlet 906.

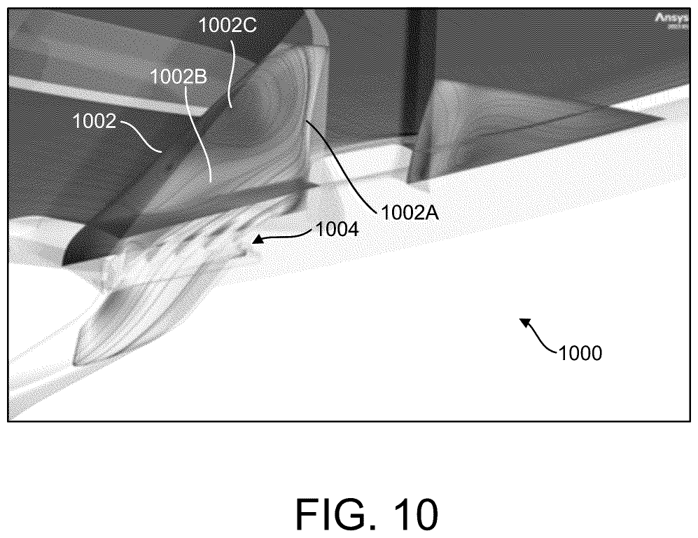

FIG. 10 shows another example of a computer simulation 1000 of air distribution for a quarter window of a vehicle. The computer simulation 1000 can be used with one or more other examples described elsewhere herein. The computer simulation 1000 is performed based on a glass pane 1002 (e.g., a quarter window), with air flowing out of an outlet 1004. The velocity of the air flow at various locations of the glass pane 1002 is indicated by the shading in the computer simulation 1000. The glass pane 1002 has an area 1002A of relatively high air velocity, an area 1002B of medium air velocity, and an area 1002C of relatively low air velocity. As such, it can be determined that the glass pane 1002 will be cleared (e.g., demisted) by the flow of air from the outlet 1004.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A vehicle comprising:
a vehicle body having a passenger compartment with first and second glass panes, the first glass pane positioned on a side of the vehicle body between, and abutting each of, a first pillar and a second pillar of the vehicle body, the second glass pane abutting an opposite side of the second pillar from the first glass pane;
a heating, ventilation and air conditioning (HVAC) system installed in the vehicle body, a duct extending from the HVAC system and delivering air for the passenger compartment; and
an outlet positioned between the first and second pillars and adjacent the first glass pane, the outlet coupled to an end of the duct that is distal from the HVAC system, the outlet including at least one vane defining multiple outlet channels for the air, wherein the multiple outlet channels are directed toward the second pillar, wherein the air reaches the first glass pane, and wherein the air reaches also the second glass pane due an aerodynamic effect of the second pillar.

2. The vehicle of claim 1, wherein the first pillar is an A-pillar of the vehicle.

3. The vehicle of claim 1, wherein the second pillar includes trim that provides the aerodynamic effect of the second pillar.

4. The vehicle of claim 1, wherein the second pillar has first and second main exterior surfaces that abut each other, and wherein the multiple outlet channels face the first main surface.

5. The vehicle of claim 4, wherein the first main surface is positioned forward of the second main surface in the vehicle.

6. The vehicle of claim 1, wherein the multiple outlet channels are not directed toward the first glass pane.

7. The vehicle of claim 6, wherein the multiple outlet channels are substantially parallel with the first glass pane.

8. The vehicle of claim 6, wherein the multiple outlet channels are directed toward a remainder of the passenger compartment.

9. The vehicle of claim 1, wherein each of the multiple outlet channels is defined by the vane and by side walls of the outlet.

10. The vehicle of claim 1, wherein the multiple outlet channels are substantially parallel with each other.

11. The vehicle of claim 10, wherein each of the multiple outlet channels is defined by an opening in the outlet, wherein a shape of the opening in a top view is substantially a rectangle.

12. The vehicle of claim 11, wherein a short side of the rectangle faces the first glass pane, and wherein in the top view the rectangle is angled forward with respect to the first glass pane.

13. The vehicle of claim 1, wherein the first glass pane is a quarter window of the vehicle.

14. The vehicle of claim 13, wherein the vehicle includes a closure configured to open and close an opening to the passenger compartment, wherein at least the second glass pane is positioned on the closure.

15. The vehicle of claim 14, wherein also the first glass pane is positioned on the closure.

16. The vehicle of claim 14, wherein the first glass pane is positioned on the vehicle body and not on the closure.

17. The vehicle of claim 15, wherein the closure further includes a window elevator for the second glass pane.

18. The vehicle of claim 1, wherein a line extends between i) a most inboard edge of the first pillar adjacent the outlet, and ii) a most inboard edge of the second pillar adjacent the outlet, and wherein the outlet is positioned outboard of the line.

19. A vehicle comprising:
a vehicle body having a passenger compartment with first and second glass panes, the first glass pane positioned on a side of the vehicle body between, and abutting each of, a first pillar and a second pillar of the vehicle body, wherein the second glass pane abuts an opposite side of the second pillar from the first glass pane;
a heating, ventilation and air conditioning (HVAC) system installed in the vehicle body, a duct extending from the HVAC system and delivering air for the passenger compartment; and
means for distributing air from the HVAC system to each of the first and second glass panes, the means positioned between the first and second pillars, wherein the air from the means reaches the first glass pane, and wherein the air from the means reaches also the second glass pane due to an aerodynamic effect of the second pillar.

20. The vehicle of claim 19, wherein a line extends between i) a most inboard edge of the first pillar adjacent the means, and ii) a most inboard of the second pillar adjacent the means, and wherein the means is positioned outboard of the line.
